(19) United States
(12) Patent Application Publication
(10) Pub. No.: US 2002/0181758 A1
(43) Pub. Date: Dec. 5, 2002

(54) Die bonding apparatus with automatic die and lead frame image matching system

(75) Inventor: Kong Lam Song, Penang (MY)

Correspondence Address: BEVER, HOFFMAN & HARMS, LLP, 2099 GATEWAY PLACE, SUITE 320, SAN JOSE, CA, 95110, US

(73) Assignee: Integrated Device Technology, Inc.

(21) Appl. No.: 09/888,363

(22) Filed: Jun. 21, 2001

(30) Foreign Application Priority Data
May 29, 2001 (MY) PI 20012544

(51) Int. Cl. G06K 9/68; G06K 9/00

(52) U.S. Cl. 382/149; 382/218

(57) ABSTRACT

A vision system that compares the captured images of a die and a lead frame loaded in a die bonding apparatus with stored images thereof, and interrupts the die bonding process when the captured images fail to match the stored images. The images are directed to distinctive features of the die (e.g., the positioning and size of the die bonding pads) and lead frame (e.g., positioning and size of the leads) that differ between various die and lead frames having similar sizes. A first camera captures the lead frame image, and a second camera captures the die image. The captured die and lead frame images are digitized and passed to a computer, which compares the captured images with previously stored images. When a mismatch is detected, the computer generates an error signal that shuts down the die bonding apparatus.

### FIELD OF THE INVENTION

This invention relates to die bonding apparatus, and more particularly to methods and systems for preventing the erroneous bonding of mismatched die and lead frames.

### BACKGROUND OF THE INVENTION

Several molded IC package types that utilize lead frames to facilitate low-cost automated production. Such molded IC package types including plastic leaded chip carriers (PLCC) and plastic quad flat packs. Each of these molded IC package types includes a molded casing surrounding an IC chip, or “die”, and several metal leads extending from the molded casing for soldering to corresponding contact pads on a printed circuit board (PCB).

FIGS. 1(A), 1(B), and 1(C) are perspective views showing an automated die bonding and subsequent packaging process for generating a molded IC device using a lead frame 100, which is simplified for descriptive purposes. Referring to FIG. 1(A), lead frame 100 is etched or stamped from a thin sheet metal strip, and includes side rails 110, cross rails 120, a die attach platform 130, and a pattern of narrow leads 140 that radiate inward from rails 110 and 120 toward die attach platform 130. Lead frame 100 is often formed from an elongated strip upon which this pattern of features is repeated several times. During a first stage of the bonding process that is shown in FIG. 1(A), a die 150 is mounted onto die attached pad 130 using, for example, an epoxy resin. A pattern of die bond pads 152 are provided on an upper surface of die 150 that are electrically connected to the integrated circuit formed therein. As shown in FIG. 1(B), after die 150 is secured to die attach pad 130, each die bonding pad 152 is electrically connected to a corresponding lead 140 of lead frame 100 by a fine-diameter gold bond wire 160 using well-established wire bond techniques. Subsequently, as indicated in FIG. 1(C), die attach pad 130, the inner ends of leads 140, die 150, and bond wires 160 are covered with a thermoset plastic casing 170 during a transfer molding operation. Note that a portion of each lead 140 is exposed along the sides of casing 170. After transfer molding, rails 110 and 120 are trimmed (removed), and the exposed portions of leads 140 are plated and formed to complete the packaging process.

FIG. 2 is a cross sectional view showing a simplified molded IC device 200 after leads 140 are separated from rails 110 and 120 (shown in FIG. 1(C)) and formed (bent) into a desired shape. Die attach pad 130 is supported the center of casing 170 to which all other elements of the molded IC package 200 are attached. Note that casing 170 is formed over bond wires 160 for protection.

As indicated in FIG. 3(A) and 3(B), a problem associated with the automated die bonding and packaging process described above arises when die 150 is mounted onto an incorrect lead frame 300 (FIG. 3(A)), or when a die 350 is erroneously mounted onto lead frame 100 (FIG. 3(B)). For cost saving reasons a single package size may be used to package several IC devices having a variety of input/output terminals (i.e., die bond pads). To support this variety, several lead frames may be produced that have the same width (e.g., distance between rails 110; see FIG. 1(A)) and length (e.g., distance between rails 120; FIG. 1(A)), but having a different number of leads. Similarly, several IC die may be produced that have the same size but a different number of die bond pads. For example, although die 150 and die 350 are the same size, and lead frames 100 and 300 are the same size, lead frame 300 (FIG. 3(A)) includes a larger number of leads 340 than contact pads 152 on die 150, whereas die 350 includes a larger number of die bonding pads 352 than leads 140 provided on lead frame 100 (FIG. 3(B)). As indicated in FIGS. 3(A) and 3(B), subsequent wire bonding between such mismatched die and lead frames produces erroneous connections that can cause an entire lot or partial lot of IC devices to be scrapped, thereby significantly increasing production costs.

U.S. Pat. No. 6,049,624 discloses a non-lot based method for assembling integrated circuits that addresses the mismatched die/lead frame problem by proposing a system in which laser scribe marks are used to identify and match each die with a corresponding lead frames. During production (e.g., during die bonding) an optical reader is used to read the scribe marks, and to verify that a die is correctly mounted on a corresponding lead frame.

A problem with the system disclosed in U.S. Pat. No. 6,049,624 is that the processes of laser scribing die and/or lead frames and subsequent optical recognition requires special database and optical equipment that substantially increases production costs.

What is needed is a method for matching an IC die to a corresponding lead frame in a die bonding apparatus that is both reliable and relatively inexpensive when compared to systems relying on laser scribing.

### SUMMARY OF THE INVENTION

The present invention is directed to an automatic image matching system that compares the captured images of a die and a lead frame loaded in a die bonding apparatus with stored images thereof, and interrupts the die bonding process when the captured images fail to match the stored images, thereby preventing costly production errors. The images are directed to distinctive features of the die (e.g., the positioning and size of the die bonding pads) and lead frame (e.g., positioning and size of the leads) that differ between various die and lead frames having similar sizes, and are captured, stored and compared using known image processing techniques. Accordingly, a low-cost matching process is provided that avoids expensive laser scribing and optical code reading required by conventional systems.

In an embodiment of the present invention, a die bonding apparatus incorporates the automatic image matching system such that the comparison process occurs before the die are mounted on the lead frames. A first camera is mounted over the work holder of the die bonding apparatus for capturing the lead frame image. A second camera is mounted over the die loading tray for capturing the die image. The captured die and lead frame images are digitized using a vision card and passed to a computer, which compares the captured die and lead frame images with previously stored die and lead frame images using known techniques. When a mismatch is detected, the computer generates an error signal that is passed through a signal controller to shut down the die bonding apparatus.

In an alternative embodiment of the present invention, a die bonding apparatus is retro-fitted with an automatic image matching system with minimum modification to the original operating system. The first and second cameras are mounted over the work holder and capture respective images of a first lead frame and a first die after the first die is mounted on the first lead frame. Each camera is tasked to capture a different region of the assembled die/lead frame structure. As in the first embodiment, discussed above, the die bonding apparatus is shut down when either of the two captured images fails to match its corresponding stored image.

Also disclosed are methods for storing and comparing die and lead frame images using the automatic image matching system described above.

### BRIEF DESCRIPTION OF THE DRAWINGS

These and other features, aspects and advantages of the present invention will become better understood with regard to the following description, appended claims, and accompanying drawings, where:

FIGS. 1(A), 1(B), and 1(C) are perspective views showing a conventional die bonding a packaging process;

FIG. 2 is cross-sectional side view showing an IC device;

FIGS. 3(A) and 3(B) are top views showing mismatched die and lead frame assemblies;

FIG. 4 is a block diagram showing a die bonding apparatus including an auto matching vision system according to an embodiment of the present invention;

FIG. 5 is a flow diagram showing a matching process utilized by the die bonding apparatus of FIG. 4;

FIG. 6 is a block diagram showing a retro-fitted die bonding apparatus including an auto matching vision system according to another embodiment of the present invention;

FIGS. 7(A) and 7(B) are plan views depicting an example of a captured lead frame image that is compared by the auto matching vision system of FIG. 6; and

FIGS. 8(A) and 8(B) are plan views depicting an example of a captured die image that is compared by the auto matching vision system of FIG. 6.

### DETAILED DESCRIPTION OF THE DRAWINGS

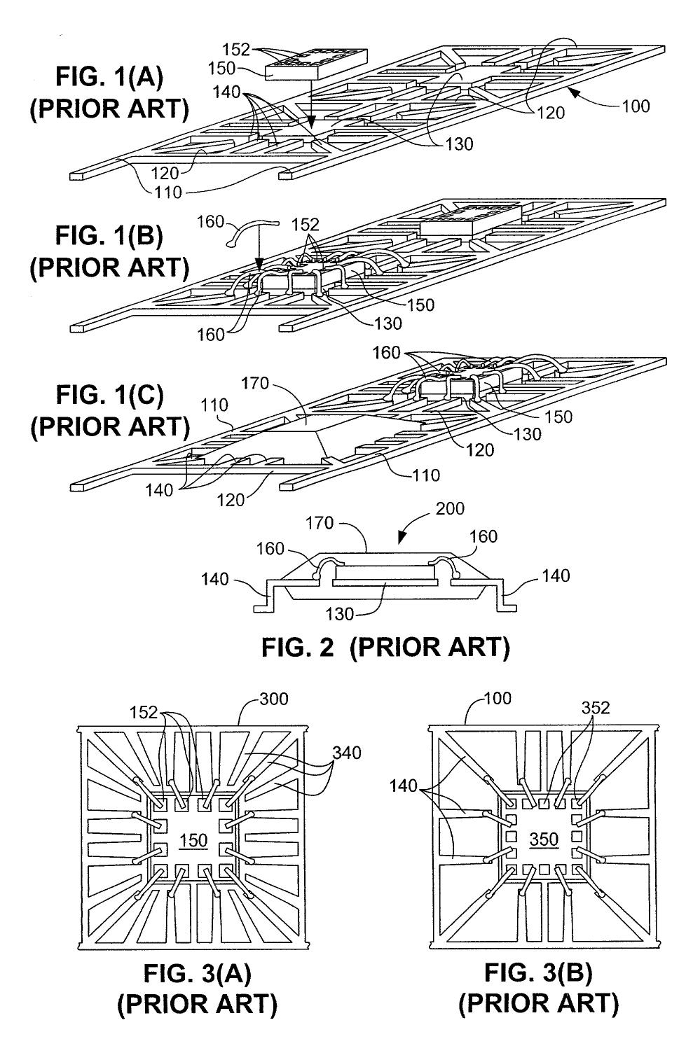

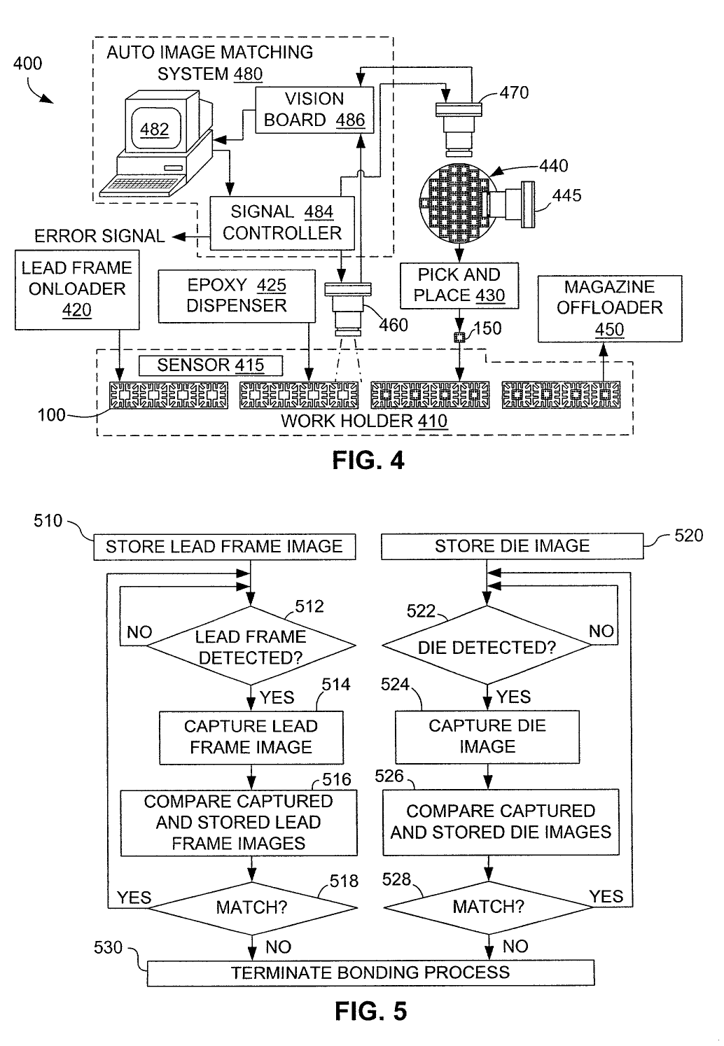

FIG. 4 shows a die bonding apparatus 400 that is used for mounting IC die 150 onto lead frame 100 (both lead frame 100 and die 150 are described in detail above). The basic die bonding process is performed using a work holder 410, a lead frame onloader 420, an epoxy dispenser 425, a handler (pick and place) apparatus 430, and a magazine offloader 450, all of which being well known. Work holder 410 is a standard conveyor-like apparatus, and includes a sensor 415 for checking the orientation of lead frame 100, which is loaded onto work holder 410 by lead frame onloader 420 using known techniques. Handler apparatus 430 is a well known device that picks up dice 150 from a work tray or wafer 440, and transports the dice 150 to lead frame 100 where dice 150 are mounted as shown in FIG. 1(A). A die bonding system camera 445 is provided to perform an ink dot recognition process, which is used to identify good (i.e., functioning) die 150. Finally, magazine offloader 450 is utilized to offload lead frames 100 for further processing.

In accordance with the present invention, die bonding apparatus 400 is provided with a lead frame (first) camera 460, a die (second) camera 470, and an automatic image matching system 480 that are utilized to prevent erroneous assembly of die 150 and an incorrect lead frame, or the erroneous assembly of an incorrect die and lead frame 100.

Lead frame camera 460 and die camera 470 (e.g., a JAI CV-M50 Industrial ½″ BW CCD Camera) are positioned relative to die bonding apparatus 400 for capturing respective lead frame and die images that are passed to automatic image matching system 480. In particular, lead frame camera 460 is positioned over work holder 410 between sensor 415 and pick and place apparatus 430. As described in additional detail below, lead frame camera 460 captures a lead frame image of the lead frame conveyed on work holder 410, and passes the captured lead frame image to automatic image matching system 480. Similarly, die camera 470 is positioned adjacent to work tray/wafer 440 to capture a die image of a die before being moved by pick and place apparatus 430 to work holder 410 for mounting on lead frame 100.

Automatic image matching system 480 compares the captured lead frame and die images with stored “known good” images, and generates a system control signal that terminates the die bonding operation if either of the captured images fails to match the stored images. In the disclosed embodiment, automatic image matching system 480 includes a computer 482, a signal controller 484, and a vision board 486. Computer 482 (e.g., a Celeron 550 Mhz processor with WINDOWS 98/ME Operating System) functions as an image processor and input/output (I/O) controller. The I/O control software utilized by computer 482 generates operating control signals that are transmitted to a signal controller 486, which converts trigger sensor signal card input and vice versa. That is, when there is an image mismatch (discussed below), computer 482 generates an error signal that is passed through signal controller 486 to terminate the bonding process. After rectifying the problem that generated the mismatch, automatic image matching system 480 is reset to restart the die bonding process. In addition to the I/O (system) control software, computer 482 is also loaded with image processing software (e.g., EasyImage and EasyMatch image processing software produced by from Euresys S. A. of Angleur, Belgium) that is compatible with vision board 484 (e.g., a Euresys Picolo vision board), which is used to capture and digitizes the lead frame and die images received from cameras 460 and 470. The image processing software loaded on computer 482 typically compares the grey level of the captured image with stored “known good” images, and scores the captured images based upon how well they compare to the stored images. As mentioned above, in the event of a mismatch, computer 482 generates error signals that are transmitted via signal controller 486 to turn off select portions of die bonding apparatus 400 (e.g., handler 430).

In one embodiment, cameras 460 and 470 are mounted on standard X-Y tables for precise positioning over work handler 410 and work tray 440, respectively. The positioning process can be either manually performed, or automated according to known techniques.

FIG. 5 is a flow diagram showing a method for operating die bonding apparatus 400 (i.e, for bonding die 150 onto lead frame 100) such that mismatched die/lead frame combinations are prevented. First, “known good” die and lead frame images are captured and stored (Steps 510 and 520). These stored images may be generated using cameras 460 and 470 (see FIG. 4) when lead frame 100 and die 150 are known to be present, or can be generated using other means. Once the stored images are present, automatic die bonding operations are performed by die bonding apparatus 400 unless either a captured lead frame image or a captured die image fails to match the stored lead frame image and stored die image, respectively. Specifically, upon detecting the presence of a lead frame (Step 512) and a die (Step 522), cameras 460 and 470 generate captured images of the detected lead frame and/or die (Steps 514 and 524) that are transmitted to computer 482 via vision card 484 (see FIG. 4). These captured images are then compared with the stored “known good” images (Steps 524 and 526) by computer 482, which generates an error signal (Step 530) that terminates the die bonding operation if either of the captured images fails to match the stored images.

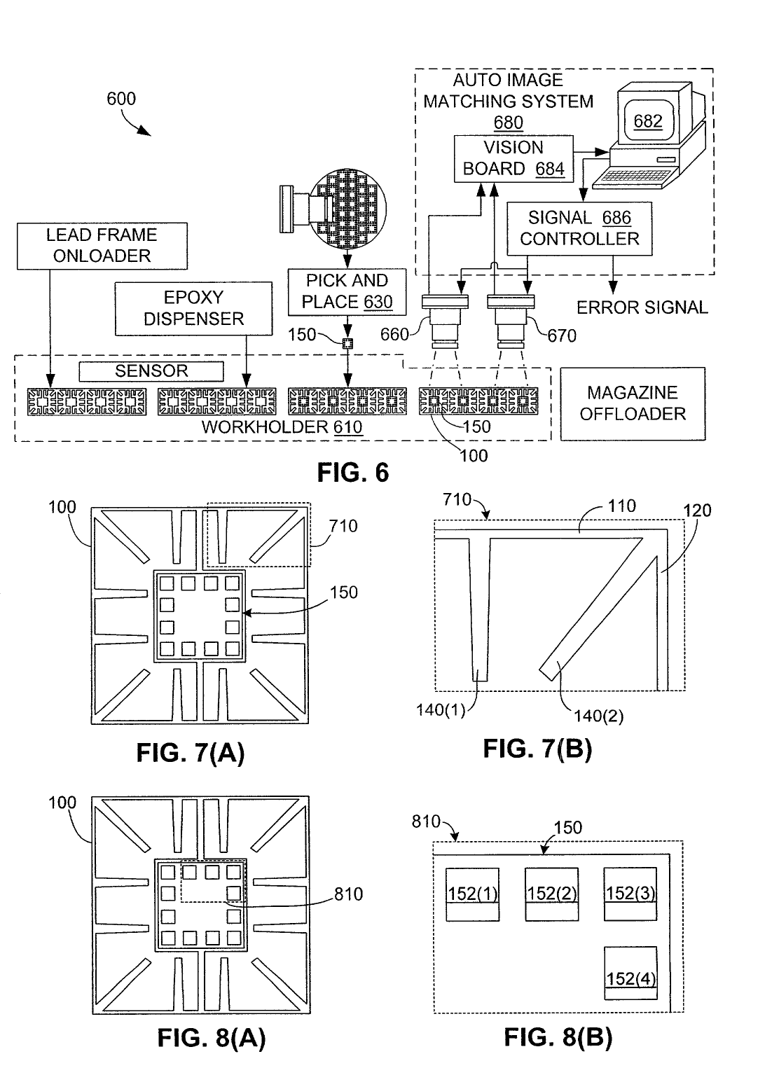

FIG. 6 is a shows a die bonding apparatus 600 (e.g., an Alphasem 9002 Die Bonding System produced by Alphasem AG of Berg, Switzerland) that is retro-fitted to include an automatic die and lead frame image matching system 680 according to another embodiment of the present invention. Die bonding apparatus includes components that are essentially identical to those shown in FIG. 4, with the exception that lead frame camera 660 and a die camera 670 are positioned downstream from the point at which handler apparatus 630 places dice 150 onto lead frames 100. Accordingly, the images captured by these cameras are processed in a manner that may be different from the system shown in FIG. 4 in that both die 100 and lead frame 150 are identified from essentially the same general image. Note also that identification of mismatched dice and lead frames occurs after a first die is mounted onto a lead frame, thereby requiring that at least one die/lead frame assembly must be discarded.

FIG. 7(A) is a plan view showing lead frame 100 with die 150 mounted thereon, and FIG. 7(B) is an enlarged plan view showing a region 710 of FIG. 7(A) that is captured by lead frame camera 660 (see FIG. 6). Referring to FIG. 7(B), the stored image that is compared with capture region 710 intentionally includes distinctive features associated with the “known good” lead frame (e.g., two leads 140(1) and 140(2) that are located in a corner formed by a portion of one side rail 110 and a portion of one cross rail 120). These distinctive features, which are intended to be exemplary and not limiting, are selected because they differ from similar structures formed on other lead frames having a similar size (e.g., lead frame 300 shown in FIG. 3(A)). In one embodiment, camera 660 magnifies the image located in region 710 by a factor of ten, and then compares this captured lead frame image with the stored “known good” lead frame image using know techniques.

Similarly, FIG. 8(A) is a plan view showing lead frame 100/die 150 indicating a region 810 that is captured by die camera 670 (see FIG. 6), and FIG. 8(B) is an enlarged plan view showing die capture region 810. Referring to FIG. 8(B), the stored die image that is compared with the captured image of region 810 includes four contact pads 152(1) through 152(4) that form a distinctive pattern on die 150. Contact pads 152(1) through 152(4) represent distinctive features associated with the “known good” die 150 that are expected in captured region 810, and that can be easily distinguished over similar contact pad patterns formed on other dies of the same size (e.g., die 350 shown in FIG. 3(B)). In one embodiment, die camera 670 magnifies the captured image located in region 810 by a factor of forty-five (45X) before comparing with the stored image.

Although the present invention has been described with respect to certain specific embodiments, it will be clear to those skilled in the art that the inventive features of the present invention are applicable to other embodiments as well, all of which are intended to fall within the scope of the present invention.

1. A die bonding apparatus for bonding an integrated circuit (IC) die onto a lead frame, the apparatus comprising:
a first camera for capturing a lead frame image corresponding to the lead frame;
a second camera for capturing a die image corresponding to the IC die; and
an automatic image matching system for comparing the captured lead frame image with a stored lead frame image, for comparing the captured die image with a stored die image, and for generating an error signal if one of the second lead frame image and the second die image fails to match the first lead frame image and the first die image, respectively.

2. The die bonding apparatus according to claim 1, wherein the auto matching vision system comprises a vision board for digitizing images received from the first and second cameras.

3. The die bonding apparatus according to claim 2, wherein the auto matching vision system further comprises a computer for storing the stored lead frame image and the stored die image, and for comparing the stored lead frame image and the stored die image with the captured lead frame image and the captured die image, respectively.

4. The die bonding apparatus according to claim 3, wherein the auto matching vision system further comprises a signal controller for transmitting an error signal to the die bonding apparatus in response to a control signal generated by the computer when one of the second lead frame image and the second die image fails to match the first lead frame image and the first die image, respectively.

5. A method for operating a die bonding apparatus, the method comprising:
storing a first lead frame image and a first die image;
capturing a second lead frame image and a second die image corresponding to a lead frame and an IC die received by the die bonding apparatus;
comparing the second lead frame image with the first lead frame image and the second die image with the first die image; and
terminating operation of the die bonding apparatus if one of the second lead frame image and the second die image fails to match the first lead frame image and the first die image, respectively.

6. The method according to claim 5, further comprising detecting a lead frame received by the die bonding apparatus.

7. The method according to claim 5, further comprising detecting a die received by the die bonding apparatus.

8. A method for bonding an integrated circuit (IC) die onto a lead frame, the method comprising:
storing a first lead frame image and a first die image;
capturing a second lead frame image and a second die image corresponding to the lead frame and the IC die to be bonded;
comparing the second lead frame image with the first lead frame image and the second die image with the first die image; and
bonding the IC die onto the lead frame only if the second lead frame image and the second die image match the first lead frame image and the first die image, respectively.
